(19) United States
(12) Patent Application Publication
(10) Pub. No.: US 2023/0333618 A1
(43) Pub. Date: Oct. 19, 2023

(54) Method for protecting a rechargeable battery

(71) Applicant: Hilti Aktiengesellschaft, Schaan (LI)

(72) Inventors: Varnim GOYAL, Landsberg am Lech (DE); Bernd ZIEGLER, Schwabmuenchen (DE)

(21) Appl. No.: 18/025,228

(22) PCT Filed: Sep. 15, 2021
(86) PCT No.: PCT/EP2021/075265

§ 371 Date: Mar. 8, 2023

(30) Foreign Application Priority Data
Sep. 24, 2020 (EP) 20198098.4

(51) Int. Cl. G06F 1/28; H02J 7/00

(52) U.S. Cl. CPC G06F 1/28; H02J 7/00032; H02J 7/00712; H02J 7/0047

(57) ABSTRACT

Method for operating a system containing at least one rechargeable battery, a data processing apparatus with a memory device, a control device, at least one sensor and a transmitting and receiving device, having the method steps of capturing values via a sensor; transmitting the captured values to the data processing apparatus using the transmitting and receiving device; comparing the captured values with threshold values stored in the memory device; storing the event that a captured value reaches a threshold value in the memory device; and adjusting the at least one rechargeable battery from a first operating state to a second operating state if a first threshold value is reached once and/or if a second threshold value is reached for a predetermined number. A system for carrying out the method is also provided.

The present invention relates to a method for operating a system containing at least one rechargeable battery, a data processing apparatus with a memory device, a control device, at least one sensor and a transmitting and receiving device.

The present invention also relates to a system for carrying out the method, wherein the system contains at least one rechargeable battery, a data processing device with a memory device, a control device, at least one sensor and a transmitting and receiving device.

### BACKGROUND

Power tools can be supplied with electrical energy and operated by means of one or more rechargeable batteries. Although modern rechargeable batteries, in particular rechargeable batteries based on lithium-ion technology, have a relatively robust structure, improper handling and extreme external conditions may. These external conditions may include, for example, high outside temperatures or high humidity.

Modern rechargeable batteries often contain one or more sensors and a control apparatus in order to detect the wide variety of influences on the rechargeable battery. The control apparatus in turn contains a memory device containing stored threshold values. The values captured by the sensors are accordingly compared with the threshold values. The reaching of a threshold value stored in the memory device is therefore used as an indicator of potential damage, a malfunction and/or upcoming failure of the rechargeable battery. If the system detects that a threshold value has been reached by a captured value, an appropriate measure can be taken. A measure may be, for example, the emission of a warning signal to the user of the rechargeable battery by means of a display apparatus, as a result of which the user has been made aware of a possible problem and should no longer operate the rechargeable battery.

### SUMMARY OF THE INVENTION

However, a problem in connection with such rechargeable batteries containing capture and warning apparatuses is that they often emit a warning signal much too early, that is to say even before there is a true technical problem with the rechargeable battery. For fear of possible danger, the rechargeable battery is no longer used or is even disposed of as a result, even though it is still fully functional.

In addition, there is also the problem of a warning signal occasionally not being emitted at all or being emitted too late, even though there is already a technical malfunction in the rechargeable battery.

An object of the present invention is to solve the problem mentioned above and to provide a method for operating a system containing at least one rechargeable battery, a data processing apparatus with a memory device, a control device, at least one sensor and a transmitting and receiving device, and to provide a system for carrying out the method, which can be used to achieve better monitoring of the functions of a rechargeable battery.

The present invention provides a method for operating a system containing at least one rechargeable battery, a data processing apparatus with a memory device, a control device, at least one sensor and a transmitting and receiving device.

According to the invention, the method comprises the method steps of:
capturing values by means of the at least one sensor;
transmitting the captured values to the data processing apparatus using the transmitting and receiving device;
comparing the captured values with threshold values stored in the memory device;
storing the event that a captured value reaches a threshold value in the memory device; and
adjusting the at least one rechargeable battery from a first operating state to a second operating state if a first threshold value is reached once and/or if a second threshold value is reached for a predetermined number.

According to one advantageous embodiment of the present invention, it may be possible for an output of electrical energy from the at least one rechargeable battery to be at least temporarily blocked by adjusting the at least one rechargeable battery from the first operating state to a second operating state. This makes it possible to prevent a possibly damaged rechargeable battery from being damaged further. In addition, the blocked output of electrical energy is used as an indicator of a malfunction and/or damage to the rechargeable battery.

According to one advantageous embodiment of the present invention, it may be possible for an intake of electrical energy into the at least one rechargeable battery to be at least temporarily blocked by adjusting the at least one rechargeable battery from the first operating state to a second operating state. This likewise makes it possible to effectively prevent a possibly damaged rechargeable battery from being damaged further. Furthermore, the blocked intake of electrical energy is used as an indicator of a malfunction and/or damage to the rechargeable battery.

According to one advantageous embodiment of the present invention, it may be possible for at least one signal to be emitted by the transmitting and receiving device by adjusting the at least one rechargeable battery from the first operating state to a second operating state. The from the transmitting and receiving device may be received, for example, by an external unit, for example a smartphone, and may indicate a malfunction and/or damage to the rechargeable battery to a user. Emitting an appropriate signal to an external unit using a reproduction or display apparatus (for example smartphone) makes it possible to indicate in detail the malfunction and/or damage to the rechargeable battery or the affected component to the user of the rechargeable battery.

According to one advantageous embodiment of the present invention, it may be possible for the threshold values stored in the memory device to be changed by adjusting the at least one rechargeable battery from the first operating state to a second operating state. As a result, the rechargeable battery can be adjusted to new threshold values if there are further empirical values for this.

The present invention also provides a system for carrying out the method.

According to one advantageous embodiment of the present invention, it may be possible for the data processing device to be in the form of an external IT infrastructure, in particular cloud computing. This makes it possible to centrally process and store a very large volume of data. As a result of the generally simple possible ways of accessing a data processing apparatus in the form of a cloud, data and information can be transmitted to a plurality of rechargeable batteries at the same time in a relatively simple manner. Furthermore, by virtue of the data processing apparatus in the form of a cloud, it is also easier to manage and update a large number of rechargeable batteries.

According to one advantageous embodiment of the present invention, it may be possible for the at least one rechargeable battery to contain the data processing device.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to produce useful further combinations.

In the figures:

FIG. 1 shows a system according to the invention having a first rechargeable battery, a data processing apparatus with a memory device, a control device, at least one sensor and a transmitting and receiving device according to a first exemplary embodiment;

FIG. 2 shows the system according to the invention having the first rechargeable battery and an external data processing device according to a second exemplary embodiment; and

FIG. 3 shows the system according to the invention having the first rechargeable battery, the external data processing device and a second, a third and a fourth rechargeable battery according to the second exemplary embodiment.

### DETAILED DESCRIPTION

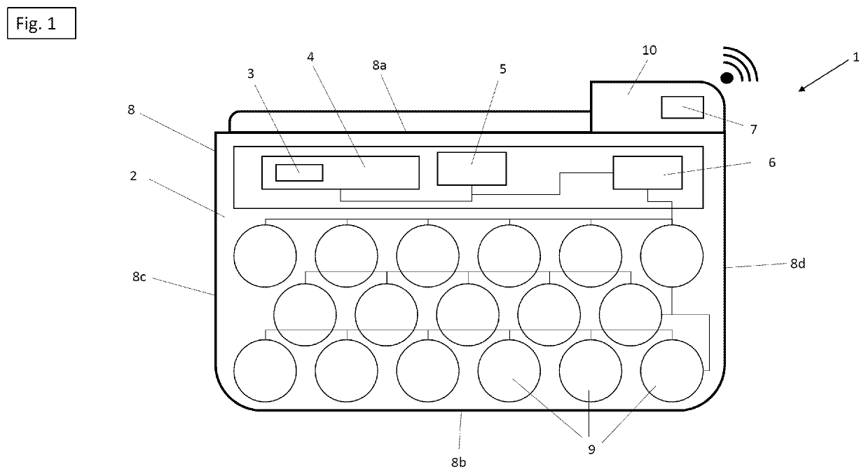

FIG. 1 shows a first system 1 according to the invention having a rechargeable battery 2, a data processing apparatus 3 with a memory device 4, a control device 5, at least one sensor 6 and a transmitting and receiving device 7 according to a first exemplary embodiment.

In this case, the rechargeable battery contains a housing 8, a number of energy storage cells 9, the data processing apparatus 3 with the memory device 4, the control device 5, the sensor 6 and the transmitting and receiving device 7.

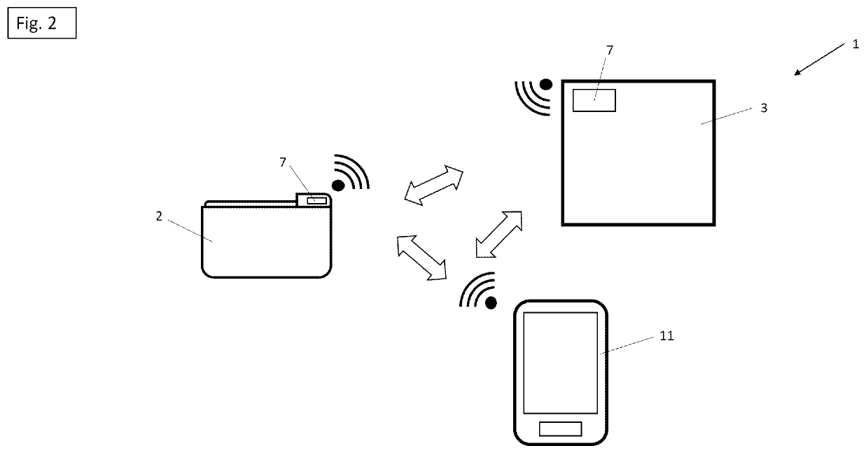

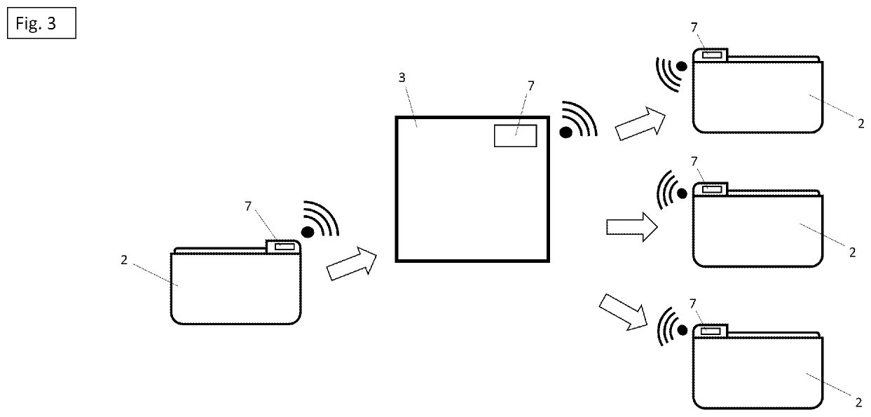

A further exemplary embodiment of the system 1 according to the invention is shown in FIGS. 2 and 3.

The energy storage cells 9 can also be referred to as rechargeable battery cells and are based on lithium-ion technology.

In the present exemplary embodiment of the present invention, the data processing apparatus 3 contains the memory device 4. According to an alternative exemplary embodiment of the present invention, the memory device 4 may also be in the form of a separate component. If the memory device 4 is in the form of a separate component, the data processing apparatus 3 and the memory device 4 are connected to one another.

The housing 8 of the rechargeable battery 2 contains an upper side 8a, a lower side 8b, a front side 8c and a rear side 8d.

An interface device 10 is provided on the upper side 8a of the housing 8. The interface device 10 can be used to releasably connect the rechargeable battery 2 to a power tool in order to output the electrical energy stored in the energy storage cells to the power tool.

The power tool may be in the form of a drilling machine, hammer drill, cordless screwdriver, saw, grinding device or the like. The power tool is not illustrated in the figures.

In addition, the interface device 10 of the rechargeable battery 2 can be used to releasably connect to a charging apparatus (also called a charger) in order to charge the energy storage cells 9 with electrical energy.

The control device 5 is positioned in the vicinity of the upper side 8a of the housing 8 of the rechargeable battery 2 and is substantially used to monitor and control the operation of the rechargeable battery 2. In addition, the control device 5 can change the rechargeable battery 2 to different operating states. It is therefore possible, for example, on account of a particular event, for the control device 5 to change the rechargeable battery 2 to a state in which electrical energy can neither be taken in nor output by the energy storage cells 9. Such a change to the operating state may be made on account of a possible malfunction of the rechargeable battery 2 or of the energy storage cells 9.

The transmitting and receiving device 7 is positioned on the upper side 8a of the housing 8 of the rechargeable battery 2 in the interface device 10 and is used both to emit and to receive signals. Signals can be transmitted from the rechargeable battery 2 to an external unit or apparatus 11 and can be received from the latter by means of the transmitting and receiving device 7.

The external unit 11 may be, for example, a smartphone or another rechargeable battery 2.

In the present exemplary embodiment, the transmitting and receiving device 7 is based on Bluetooth technology. According to an alternative exemplary embodiment, the transmitting and receiving device 7 may also be based on RFID technology (radio-frequency identification) and, in particular, on NFC technology (Near Field Communication) or on any other wireless data transmission technology. As indicated in FIG. 1, the transmitting and receiving device 7 is connected to the data processing apparatus 3, the memory device 4 and the control device 5 in such a manner that signals and data can be interchanged.

The sensor 6 is likewise positioned in the vicinity of the upper side 8a of the housing 8 of the rechargeable battery 2. In the present exemplary embodiment, the sensor 6 is in the form of a temperature sensor (that is to say thermometer) and is connected to the data processing apparatus 3 and to the control device 5. As illustrated in FIG. 1, the temperature sensor 6 is connected to each individual energy storage cell 9 in such a manner that the temperature can be captured at each individual energy storage cell 9.

According to a further exemplary embodiment of the present invention, the sensor 6 may alternatively also be the form of a gyro sensor (or acceleration sensor), a voltage sensor or a pressure sensor. The sensor 6 is substantially used to capture at least one state value of the energy storage cells 9 and to transmit it to the data processing apparatus 3. In addition, it is also possible to provide more than one sensor 6 for capturing different state values.

As indicated in FIG. 1, the data processing apparatus 3 with the memory device 4 is positioned in the vicinity of the upper side 8a of the housing 8 of the rechargeable battery 2. The data processing apparatus 3 is used to process state values of the rechargeable battery 2 or components of the rechargeable battery 2 which are captured by the sensor 6. The control device 5 and the data processing apparatus 3 are connected to one another in such a manner that signals and data can be interchanged between the control device 5 and the data processing apparatus 3.

Threshold values, inter alia, are stored or saved in the memory device 4. The state values captured by the sensor 6 are compared with the threshold values by means of the data processing apparatus 3. The reaching or exceeding of a threshold value by a captured value is detected by the data processing apparatus 3 and is stored in the memory device 4.

Furthermore, the data processing apparatus 3 is also configured such that the number of times particular state values are captured is also registered by the data processing apparatus 3 and stored in the memory device 4, even if the respective value captured by the sensor 6 has not yet reached or exceeded the corresponding threshold value at all. For example, the number of occurrences of acceleration values, which are captured by means of the gyro sensor and are still below the respective threshold value, is thus registered by the data processing apparatus 3 and stored in the memory device 4.

If it is registered by the data processing apparatus 3, with the aid of the threshold values stored in the memory device 4, that a state value of the rechargeable battery 2 which is captured by the sensor 6 has reached a threshold value, a corresponding signal is transmitted to the control device 5. The control device 5 changes the rechargeable battery 2 from one operating state to another by means of the emitted signal. According to a first measure, the further output of electrical energy from the energy storage cells 9 is therefore blocked or prevented by the control device 5 if the sensor 6 in the form of a temperature sensor captures a temperature at an energy storage cell 9 that corresponds to a stored temperature threshold value. An excessively high temperature of an energy storage cell 9 may indicate a possible malfunction of the rechargeable battery 2. However, it is also possible in this case for the blocking or prevention of the output of electrical energy from the energy storage cells 9 to a power tool to be limited to a certain period until the temperature of the energy storage cells 9 has fallen below the temperature threshold value again. If the temperature sensor 6 captures a temperature which is lower than the temperature threshold value, electrical energy can be output from the energy storage cells 9 to the power tool again.

It is likewise also possible for the intake of electrical energy into the energy storage cell 9 to be blocked or prevented if the sensor 6 captures a state value of the rechargeable battery 2 that has reached the respective threshold value.

New threshold values can be included in the memory device 4 by the transmitting and receiving device 7. In this case, the new threshold values may replace or supplement the already existing threshold values. If better threshold values have been determined on account of further research and development work or from experience, the rechargeable batteries 2 are equipped with these threshold values.

Furthermore, according to a second measure, a corresponding signal is transmitted to a smartphone 11 of the user of the rechargeable battery 2 by the transmitting and receiving device 7. As a result of the emitted signal, the user can see the notification on the smartphone that there is a possible malfunction in the rechargeable battery 2.

As indicated in FIG. 2, according to an alternative exemplary embodiment, the data processing apparatus 3 is in the form of an external or independent component of the system. The data processing apparatus 3 contains a transmitting and receiving device 7, with the result that signals and data can be interchanged between the rechargeable battery 2 and the external data processing apparatus 3. In the present exemplary embodiment, the data processing device 3 is in the form of an external IT infrastructure. The external IT infrastructure is cloud computing (also called a cloud).

According to this further embodiment of the present invention, the sensor 6 captures state values of the rechargeable battery 2 which are transmitted to the external data processing device 3 in the form of a cloud by means of the transmitting and receiving device 7. The captured state values are compared with stored threshold values in the data processing device 3 in the form of a cloud. If a captured state value has reached or exceeded a corresponding threshold value, a corresponding signal is transmitted to the rechargeable battery 2 by the transmitting and receiving device 7. The signal is forwarded to the control device 5. The control device 5 interprets and evaluates the signal and causes particular measures to be carried out in accordance with the reaching of a threshold value in the rechargeable battery 2. As already mentioned above, an appropriate measure may be the blocking of a further output of electrical energy from the energy storage cells 9.

In addition, the data processing apparatus 3 in the form of a cloud can also be used as a central management, control and updating apparatus. As shown in FIG. 3, it is possible for the data processing device 3 in the form of a cloud to simultaneously interchange signals and data with a plurality of rechargeable batteries 2.

If changed temperature threshold values are determined for the rechargeable batteries 2, they are stored only in the data processing apparatus 3 in the form of a cloud. The comparison in order to determine whether a state value captured by a sensor 6 in a particular rechargeable battery 2 has reached or has already exceeded a corresponding threshold value is determined in the external data processing apparatus 3.

If, for example, state values with respect to the state of charge or SoC or the state of health or SoH are captured by means of one or more sensors 6 in a rechargeable battery 2, they can be transmitted to the data processing apparatus 3 in the form of a cloud. The data processing apparatus 3 can determine a remaining life for the respective rechargeable battery 2 on the basis of the captured state values for the SoC and/or SoH. This is possible, in particular, if the rechargeable battery 2 transmits state values for the SoC and/or SoH, which are captured over a longer period or regularly, to the data processing apparatus 3. A relatively reliable statement regarding the period in which the rechargeable battery 2 is still fully functional can be determined by means of the captured and stored state values by means of extrapolation or projections. Such calculations are improved by collecting and basing the calculation on corresponding state values of different rechargeable batteries 2.

### LIST OF REFERENCE SIGNS

1 System

2 Rechargeable battery

3 Data processing apparatus

4 Memory device

5 Control device

6 Sensor

7 Transmitting and receiving device

8 Housing of the rechargeable battery

8a Upper side of the housing

8b Lower side of the housing

8c Front side of the housing

8d Rear side of the housing

9 Energy storage cell

10 Interface device

11 External unit

1-8. (canceled)

9. A method for operating a system containing at least one rechargeable battery, a data processing apparatus with a memory device, a control device, at least one sensor and a transmitting and receiving device, the method comprising the steps of:
capturing values via the at least one sensor;
transmitting the captured values to the data processing apparatus using the transmitting and receiving device;
comparing the captured values with threshold values stored in the memory device;
storing an event of a captured value reaching a threshold value in the memory device; and
adjusting the at least one rechargeable battery from a first operating state to a second operating state if a first threshold value is reached once or if a second threshold value is reached for a predetermined number.

10. The method as recited in claim 9 wherein an output of electrical energy from the at least one rechargeable battery is at least temporarily blocked by adjusting the at least one rechargeable battery from the first operating state to a second operating state.

11. The method as recited in claim 9 wherein an intake of electrical energy into the at least one rechargeable battery is at least temporarily blocked by adjusting the at least one rechargeable battery from the first operating state to a second operating state.

12. The method as recited in claim 9 wherein at least one signal is emitted by the transmitting and receiving device by adjusting the at least one rechargeable battery from the first operating state to a second operating state.

13. The method as recited in claim 9 wherein the threshold values stored in the memory device are changed by adjusting the at least one rechargeable battery from the first operating state to a second operating state.

14. A system for carrying out the method as recited in claim 9, the system comprising the at least one rechargeable battery, the data processing device with the memory device, the control device, the at least one sensor and the transmitting and receiving device.

15. The system as recited in claim 14 wherein the data processing device is in the form of an external IT infrastructure.

16. The system as recited in claim 14 wherein the external IT infrastructure is a cloud.

17. The system as recited in claim 14 wherein the at least one rechargeable battery contains the data processing device.
